(19) United States
(12) Patent Application Publication
(10) Pub. No.: US 2013/0073325 A1
(43) Pub. Date: Mar. 21, 2013

(54) Method of Event and Venue Planning and Delivering System

(71) Applicant: Warren Ross, Mechanicsville, VA (US)

(72) Inventor: Warren Ross, Mechanicsville, VA (US)

(21) Appl. No.: 13/622,200

(22) Filed: Sep. 18, 2012

Related U.S. Application Data
(60) Provisional application No. 61/537,280, filed on Sep. 21, 2011.

(51) Int. Cl. G06Q 50/14; G06Q 30/06; G06Q 30/02; G06Q 10/02

(52) U.S. Cl. 705/6

(57) ABSTRACT

A method of event and venue planning and delivering system includes a plurality of user account and a plurality of host accounts. Each of the plurality of host account can uploads a plurality of destination into a website. Each of the plurality of user accounts completes a plurality of preference surveys during the registration process. When the user account prompts the website to generate a specific tour, a planning engine plans the specific tour which includes desired destination from the plurality of destinations. Then the specific tour is displayed to the user account through an electronic calendaring system. Once the user account chooses final selections for the specific tour, the specific tour is assigned into a finalized tour. Then the finalized tour can be purchased through an online transaction by the user account.

The current application claims a priority to the U.S. Provisional Patent application Ser. No. 61/537,280 filed on Sep. 21, 2011.

### FIELD OF THE INVENTION

The present invention relates generally to a system and method for a trip planning application. More specifically, the application assembles travel information catered to a user's specific interests and assists the user in selecting and planning for a personalized travel experience that delivers the information to a mobile computing device and/or in printed format.

### BACKGROUND OF THE INVENTION

The Internet has virtually eliminated travel agents, leaving travelers to figure out the travel process for themselves. The research process to find what meets the taste of a particular traveler can be overwhelming and exhausting. Travelers have to hunt and peck through a myriad of sources containing thousands of choices. Most people start the travel process without even knowing what they want to do or what is available. Tools such as Travelocity, Expedia, TripAdvisor, and Yahoo give destination choices but based on a touristy ranking, not anything specific to the traveler's likes and dislikes. It is therefore an object of the present invention to put local knowledge back into the travel process. The present invention integrates the entire travel process from planning, scheduling, booking, to doing and the end user generated content of telling. It is a further object of the present invention to provide world class destination event choices that are matched and delivered to the traveler based on the traveler's preferences and travel plans. This is the competitive differentiator of the present invention. It is still a further object of the present invention to help the traveler get the most of their travel time and money, make travel much more enjoyable, and make it easy and painless to plan a trip. Travel Destination and Event sources include the use of an open source crawler to aggregate event and venue information across the internet and placed into a database with other event and venue information.

### BRIEF DESCRIPTION OF THE DRAWINGS

FIG. 1 is a simplified flow chart illustrating the present invention from the perspective view of a user account.

FIG. 2 is a simplified flow chart illustrating the present invention from the perspective view of a host account.

FIG. 3 is a simplified flow chart illustrating the overall process of the present invention.

FIG. 4 is a simplified flow chart illustrating a specific tour of the present invention.

### DETAIL DESCRIPTIONS OF THE INVENTION

All illustrations of the drawings are for the purpose of describing selected versions of the present invention and are not intended to limit the scope of the present invention.

The present invention is a system and method for a trip planning application. The present invention provides local knowledge about a destination to a traveler planning a trip. The present invention changes the way people think about travel. The present invention focuses on the planning, scheduling, and experiencing tours.

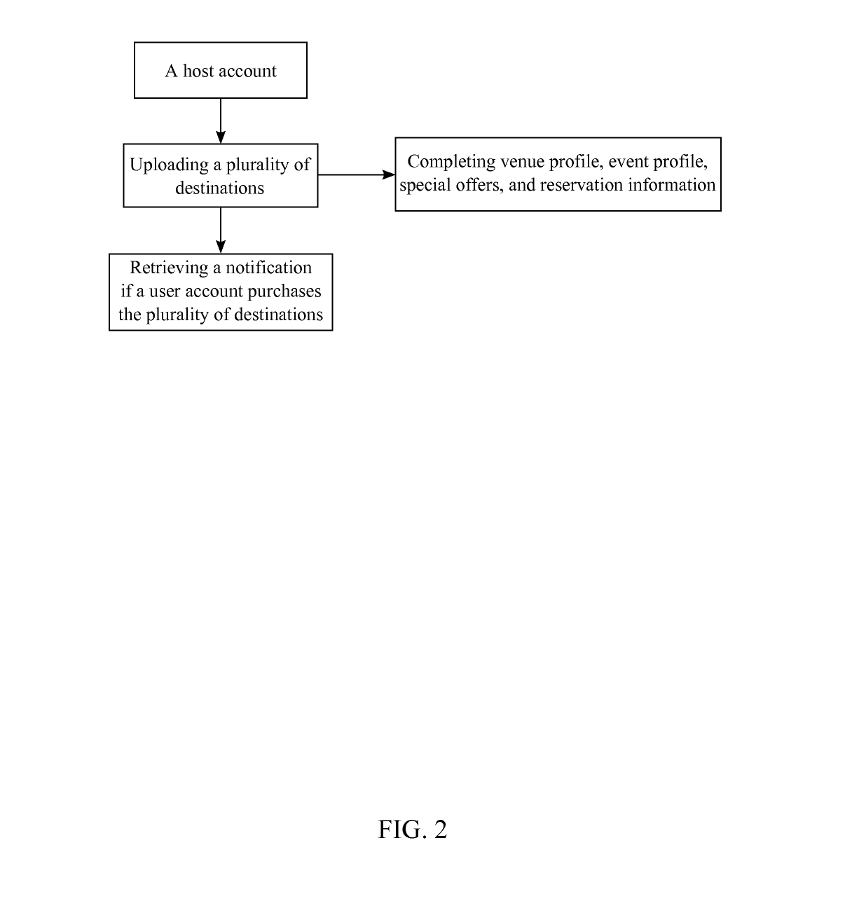

In reference to FIG. 2, the present invention is a website which includes a plurality of host accounts and a plurality of user accounts. The website presents customized videos and articles to attract the plurality of user accounts and the plurality of host accounts. The present invention prompts the plurality of host accounts uploads a plurality of destinations to the website. The plurality of host accounts can reside in the plurality of destinations or can have connection to the travel industry as former travel agents. Since the plurality of destinations can be uploaded by each of the plurality of host accounts, each of the plurality of host account gets to update and manage the plurality of destinations. The present invention provides the plurality of host accounts with the facility for remote access via http to a portal that allows the plurality of host accounts to use an input form to place information. The present invention allows the plurality of host accounts to advertise the plurality of destinations to targeted customer group so that the advertising process can be optimized. The plurality of destinations is also electronically uploaded from convention and visitor bureaus all around the world. The plurality of destinations describes compelling local destinations and event options. The plurality of destinations is uploaded into the present invention through the input form and stored within a content database. The plurality of destinations includes information regarding venue profiles, event profiles, special offers, and reservation information. All of the information uploaded through the input form of the present invention is categorized into the event profile, the venue profile, the special offers, and the reservation information so that the uploaded information can be organized.

Once the following information is uploaded through the input form, the information is organized within the event profile. The host account first completes a name of event, a short description of event, and a long description of event. Then the host account uploads event pictures where the event pictures provide the visual aspect of the plurality of destinations. The event pictures of event location can be obtained as royalty-free images from online site, such as shutterstock.com, publicdomainpictures.net, dreamstime.com, fotolia.com, istockphoto.com, gettyimage.com, and similar applications. The event pictures of the event location can also be obtained from organizers of the event or from hired services. Then the host account selects relevant categories of interest (COI) or survey questions where the COI are selected from a drop-down list. Then relevant sub categories of interest (SCOI) based upon the COI are also selected from a drop-down list. Then the host account selects an event start date and an event end date where the present invention prompts a question to the host account, asking if the event runs continuously. If the answer is yes for the question, a follow up question is prompted to the host account, asking what dates. If the answer is no for the question, the host account can skip the question. Regardless if the event runs continuously or not, the host account then selects event hours for the event. For example, if the event takes place at a national park, daily opening and closing times of the national park can be uploaded. If the event is a musical concert, specific opening and closing times can be uploaded. Then the host account completes admission information such as, are tickets required to get in, prices of tickets if tickets are available, average price of tickets or admission, and information about blackout dates or exclusions. Then related reviews and contact information, such as phone numbers, address, emails, related websites, and contact persons, are completed by the host account.

Information uploaded from the input form such as geographical location, location map, and any other related information related to the venue are organized within the venue profile. The host account then uploads information such as coupons, special discounts, or any other related promotion information through the input form. The coupons, special discounts, and any other related promotion information are organized within the special offers. Relevant information with reference to booking the event, such as a reservation link and box office contacts, is also completed by the host account where the relevant information is organized within the reservation information.

All of the information uploaded through the input form is then subjected to an approval process by the present invention for the accuracy of the information. Once the input form is validated by the present invention, the input form is stored within the content database, and the plurality of destinations is available for each of the plurality of user accounts.

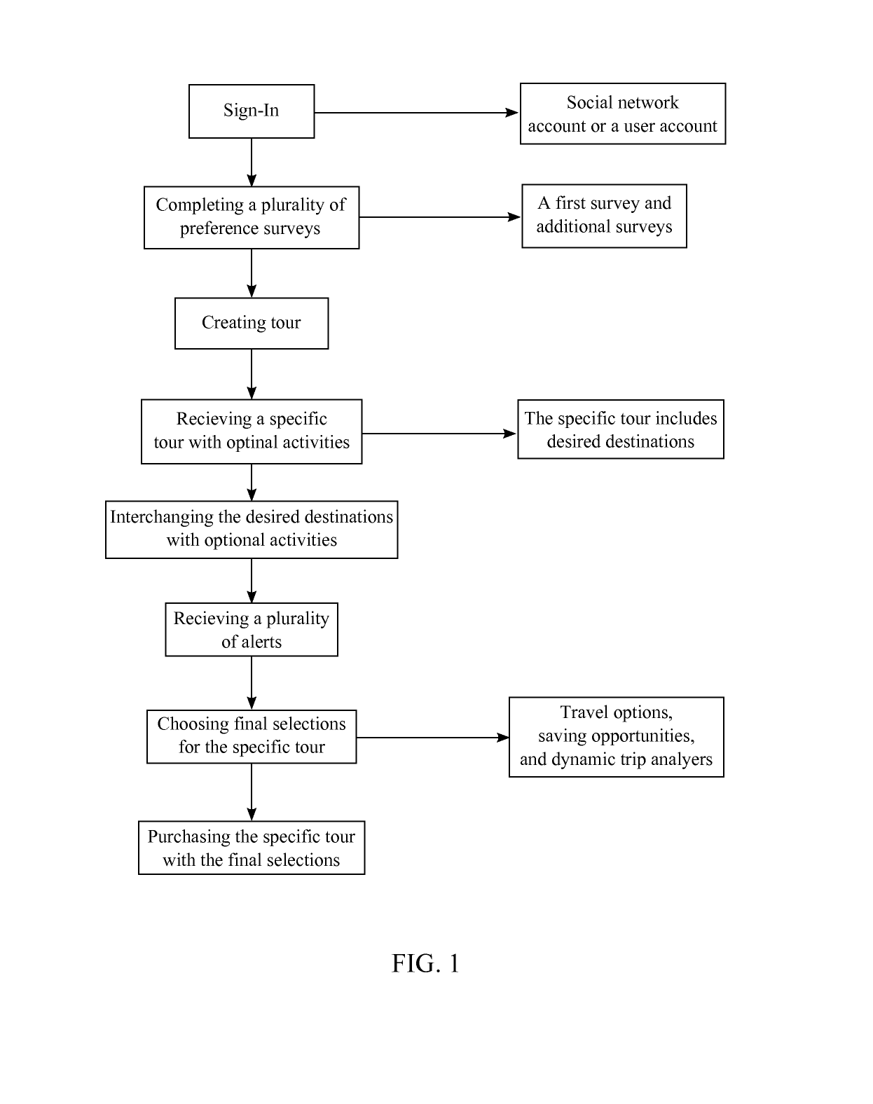

In reference to FIG. 1, in order to create each of the plurality of user accounts, the user is prompted to complete a registration process where the user creates a user name, a user password, and a user profile. The user name and the user password require at least four characters including letters, punctuation, symbols, and numbers so that the complexity can be attained for the online security of the user account while increasing the protection for the user account. The user profile comprises name, address, home city, home airport, email address, age range, phone contacts, traveled destinations, travel intentions for near future, travel wish list, information about personal and business travel, favorite cities, limitations to travel, frequency of travel, income level, passport status, and any other related information. The user name, the user password, and the user profile are stored within a member database of the present invention.

Once the user account is created within the present invention, the present invention prompts the user account to complete a plurality of preference surveys. If the user account elected not to complete the plurality of preference surveys, the present invention selectively prompts the user account to complete the plurality of preference surveys until the plurality of preference surveys are completed. Each of the plurality of preference surveys prompts questions to user account in order to identify the lifestyle of the user and to make recommendation on what to do and where to travel. Even though the user is not required to answer every question in the plurality of preference surveys, completely answered preference surveys provides the best recommendation for the user account. The plurality of preference surveys is categorized under destination preferences, data specific preferences, and trip preferences. The plurality of preference surveys is stored within the member database. Each of the plurality of preference surveys shows a progress indicator so that the user account can visualize the progress. A first survey from the plurality of preference surveys is prompted to the user account during the registration process where the user account is required to answer the first survey. When the COI are chosen in the first survey, a slider bar rating system or any other type of rating system allows the user account to precisely rate the COI. An example of the first survey which includes the COI and survey questions is listed below.
Example of the first survey:
   1. For the trip you are planning, do you have a specific date range in mind that you must adhere to?
      a. If yes, provides dates and move to question number 2
      b. If no, ask follow up question
         i. Is your date range a little flexible or is it not flexible at all?
            1. Retrieves date range from user and mark as not flexible or flexible within a certain range as appropriate.
   2. For this trip:
      a. I am traveling by myself for leisure
      b. I am traveling by myself for business
      c. I am traveling with others for leisure
      d. I am traveling with others for business
   3. For the following categories of interest (COI), please rate each category with one being low and ten being high.
      Rating scale:

| | | |
|---|---|---|
| Not this trip | ok | Love it |

| | | | | | | | | | |
|---|---|---|---|---|---|---|---|---|---|
| 1 | 2 | 3 | 4 | 5 | 6 | 7 | 8 | 9 | 10 |

1. Beach/Fun in the sun
2. Adventure/thrill seeking
3. Music
   a. Blues
   b. Christian
   c. Country
   d. Classical
   e. Dance
   f. Electronic
   g. Funk
   h. Gospel
   i. House
   j. Jazz
   k. Latino
   l. Merengue
   m. Pop
   n. R&B
   o. Rap/Hip Hop
   p. Reggae
   q. Top 40
   r. Trance
4. Sports
   a. Spectator
      i. Football
      ii. Basketball
      iii. Baseball
      iv. Hockey
      v. Soccer
      vi. Rugby
      vii. Cricket
   b. Participatory
      i. Golf
      ii. Diving/Snorkeling
      iii. Biking
      iv. Skiing
      v. Surfing
      vi. Wind gliding
      vii. Kiting/Wind-surfing
   c. Non-recurring special events (Olympics, surfing contest)
5. Restaurants/Epicurean
6. Wine-oenophile
7. Architecture and landmarks
   a. Churches/Cathedrals
   b. Skyscraper
   c. Homes/Residences
   d. Classical style
   e. Neo-classical style
   f. Baroque style
   g. Gothic style
   h. Romanesque style
   i. Victorian style
   j. Romantic style
   k. Early modern style
   l. Modern style
   m. Post modern style
   n. Deconstructivist modern style
   o. Prairie/Craftsman style
8. Art/Museums/Galleries
   a. Textiles
   b. Classical painting
   c. Modern painting
   d. Other
9. Antiques
10. Volunteering
11. Charity events
12. Film/Movies
13. Cruising
14. Boating
15. Entertainment
16. Automotive/Trains/Transportation
17. Books
18. Historical/Cultural
19. Traditional arts
20. Performing arts
21. Visual arts
22. Family fun
23. Children activities
24. Cooking
25. Technology
26. Language/Linguistic
27. Shopping
28. Sightseeing
29. Learning/Coursework
30. Real estate
31. Religious/Pilgrimage
32. Wildlife and nature
33. Travel and study abroad
34. Festivals and events
35. Nightlife and clubbing
36. Casinos
37. Amusements
38. Romance
39. Spas/Leisure
40. Exercise/Fitness
41. Self-Help (AA meeting, meditation events)
42. Cultural experiences (like china town, little Italy, etc.)

43. Walking/Hiking
44. Medical tourism
45. Single travel
46. Group travel
47. Social networking
48. Business meeting
49. Optional
4. Please identify your age group
   a. Less than 18 years
   b. 18 to 24
   c. 25-29
   d. 30-34
   e. 35-39
   f. 40-44
   g. 45-49
   h. 50-54
   i. 55-59
   j. 60-64
   k. 65-69
   l. 70-74
   m. 75-79
   n. 80-84
   o. 85-90
   p. 90 plus
5. What is your travel intention over the next three months
   a. 1 trip
   b. 2 trips
   c. 3 or more trips

Additional surveys from the plurality of preference surveys are prompted to the user account each time when the user account is activated by the user or when the user account needs to further refine the COI. The additional surveys allow the present invention to further define the preference of the user account. A slider bar rating system or any other type of rating system allows the user account to rate some of questions in the additional surveys. Over time the additional surveys are generated according to the plurality of completed preference surveys provided by the user account and according to new information from the plurality of host accounts. When the present invention retrieves new information from the plurality of host accounts, the present invention notifies the user account about the new information. The user account can turn off this feature, if the user account does not want to receive the new information. An example of one of the additional survey is listed below.
Example of the additional survey
   1. Click on the locations you have already visited and rank each from 1 to 10, 10 being the highest and 1 being the lowest.
      Present invention provides an interactive map of the world, which allows the user to click on areas of the map to identify the visited places.
      Facilitate the ability for this list to be accessed and changed by the user whenever they want.
   2. Click on locations below you want to visit sometime in your lifetime and rank each from 1 to 10, 10 being the highest and 1 being the lowest.
      Present invention provides an interactive map of the world, which allows the user to click on areas of the map to identify the visited places.
      Present invention provides a drop down list for every region of the interactive map of the world so that hard to locate areas can be selected.
      Facilitate the ability for this list to be accessed and changed by the user whenever they want.
   3. Rank from 1-10, with 10 being the highest and 1 being the lowest, the following “types” of vacations that interest you most:
      Type of Trip Rating: Low 1 2 3 4 5 6 7 8 9 10 High
      a. Beach/Fun in the sun
      b. Adventure travel
      c. Group travel
      d. Family travel
      e. Pilgrimage
      f. Study abroad travel
      g. Mancation
      h. Womancation
      i. Overseas experience
      j. Domestic travel
      k. Cruising
      l. Safari travel
      m. Train travel
      n. Ski trip
      o. Traveling to cities
      p. Traveling to the country
      q. Culinary travel
      r. Historic travel
      s. Gambling
      t. Full service resorts
   4. Do you always know where you would like to travel to, or are you open to recommendations based upon what we know about you?
   5. For personal travel, do you usually know where you want to travel or are you willing to consider recommendations? Y/N
   6. How many leisure trips do you take per year?
   7. How many business trips to you take per year?
   8. Including yourself, how many members are in your immediate family?
   9. Do you have children in your family? Y/N
      a. If Y, query for how many
      b. If Y, do your children always travel with you?
   10. Identify your home airport
      a. Ask for airport name (by dropdown list) but store as three letter code as that is what we will want to pass to booking partner for airline reservations
   11. Do you have any limitations to traveling Y/N
      If Y, query for the following:
      a. I don't have a passport
      b. Members of my immediate family do not have a passport
      c. Limited walking
      d. Unable to walk, in wheelchair or other walking impediment
      e. I have a service animal
      f. Other travel limitation
   12. Do you own a passport? (if not already answered in question 11)
   13. Do all the members of your immediate family own a passport? (if not already answered in question 11)
   14. Please provide the zip code of your primary residence? (show an alternate for non-US customers, postal code, country name and city, etc)
   15. Please indicate your approximate annual household income.
      a. Less than $25,000 US Dollars
      b. $25,001 to $40,000 US Dollars
      c. $40,001 to $50,000 US Dollars
      d. $50,001 to 60,000 US Dollars
      e. $60,001 to $75,000 US Dollars
      f. $75,001 to $100,000 US Dollars
      g. $100,001 to $125,000 US Dollars
      h. $125,000 to $150,000 US Dollars
      i. $150,000 to $200,000 US Dollars
      j. $200,001 US Dollars and above
      k. Decline to answer

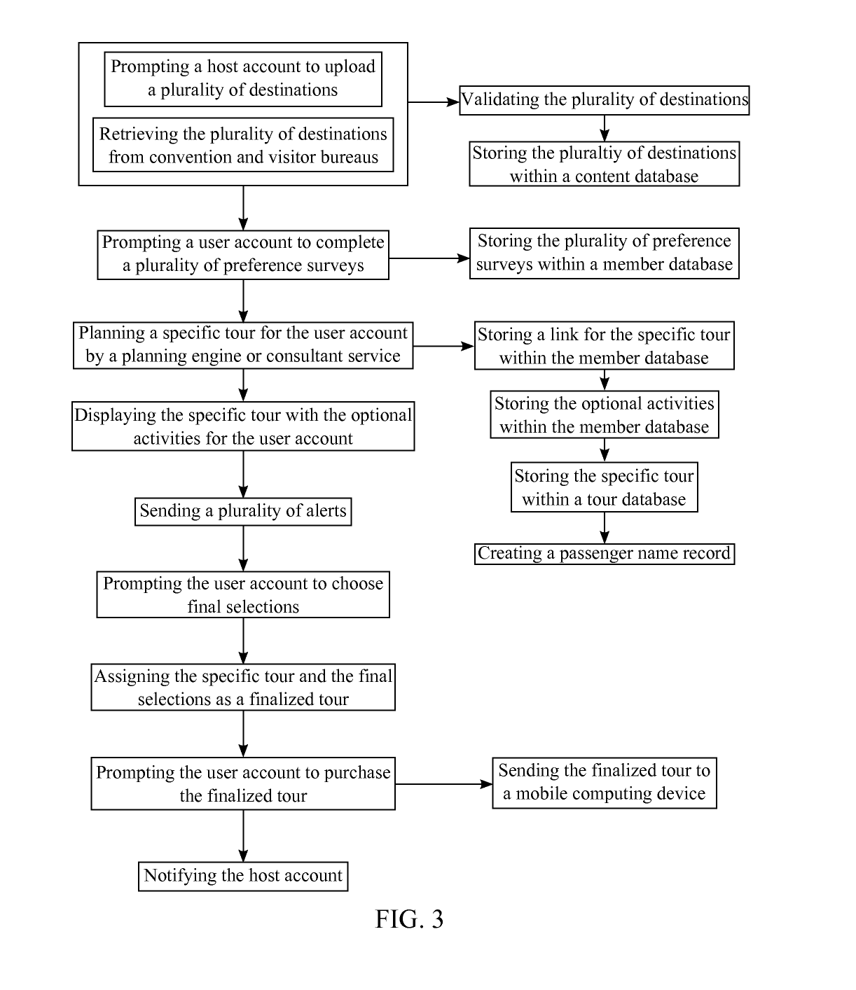

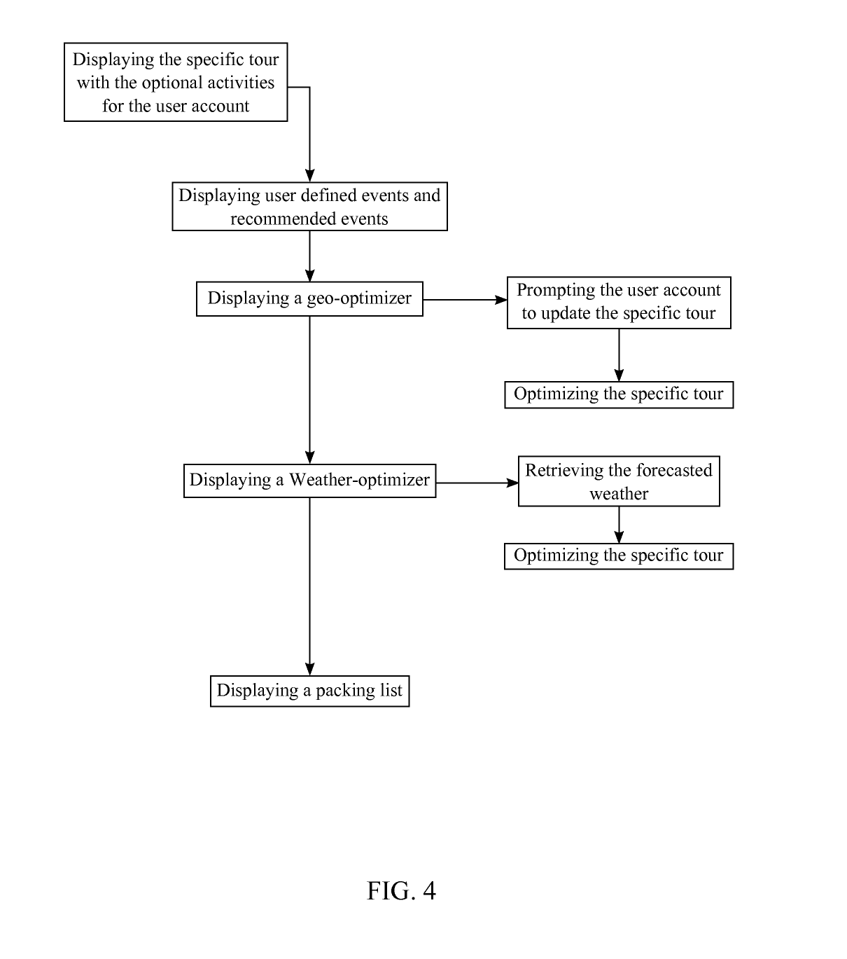

In reference to FIG. 3 and FIG. 4, a planning engine in the present invention then plans a specific tour with optional activities for the user account according to the plurality of preference surveys. The planning engine can also plan the specific tour with optional activities for multiple travels that have the different COI. In order to generate the specific tour, the planning engine follows basic workflow method. First, the planning engine retrieves whether the user account already has travel arrangements or event arrangements. If the user account have travel arrangement or event arrangements, the planning engine retrieves definite start and end dates of the travel arrangements or the event arrangements from the user account. Then the specific tour is generated within the definite start and end dates. If the user account does not have travel arrangements or event arrangements, the planning engine retrieves flexible start and end dates from the user account. Then the specific tour is generated within the flexible start and end dates.

The specific tour includes desired destinations from the plurality of destinations. The desired destinations match with the plurality of preference surveys completed by the user account. If the user of the present invention wants to create the specific tour with the help of travel agents, the user account is able to create the specific tour with a consultant service in the present invention. The consultant service provides human interaction to the user so that the user can create a customized specific tour. The consultant service may also complete the plurality of preference surveys for the user account. The user account can contact the consultant service through the website where the consultant service includes pool of travel agents. If the specific tour is created with the consultant service, the consultant service uploads the specific tour to the website so that the other user accounts of the present invention can view the specific tour uploaded by the consultant service. The specific tour created by the consultant service visually differentiates from the specific tour created by the planning engine so that each of the plurality of user account can easily identify the difference. When the first specific tour is created by either the planning engine or the consultant service, the first specific tour is entirely based on the plurality of completed preference surveys.

The specific tour is created by the present invention according to the plurality of preference surveys and includes the desired destinations from the plurality of destination. The specific tour is stored within a tour database of the present invention. If the specific tour is not completely finalized, the user can finish the specific tour when the user revisits the website. A link to the specific tour is then created and stored within the member database. The specific tour is displayed to the user account through an electronic calendaring system where the electronic calendaring system is powered by the planning engine. If the specific tour includes the plurality of user accounts and the different COI, such as group traveling, each of the plurality of user accounts is supplied with an individual electronic calendaring system and each of the individual electronic calendaring system from the plurality of user account is connected to a master electronic calendaring system.

Each of the desired destinations in the specific tour may display with a function of time view, a week view, an entire tour view, an event view, or an icon view so that the electronic calendaring system can be cleanly presented to the user account upon user's preference. The week view displays the specific tour with a weekly view. The entire tour view displays the specific tour with a daily view. The event view displays the specific tour with a daily view but the daily view indicates must do events, nice to do events, and interesting to do events. The icon view shows the specific tour with graphically showing events along the specific tour. For example, hiking events can be presented by walking person with a pole. While the specific tour displays within the electronic calendaring system, the optional activities display below the electronic calendaring system. The optional activities comprise user defined events and recommended events. The recommended events are generated by the planning engine according to the plurality of completed preference surveys. The user define events are created by the user account where the user defined event includes must attend events and optional to attend event. If the user is not sure about where the user wants to travel, the recommended events can function as a guide to the user. The user account can also notify the present invention regarding incorrect and missing information in the recommended event. The user account can also access reviews through the website for each of the plurality of destinations, where the reviews are uploaded by the plurality of user accounts.

The user account can selectively interchange the desired destinations in the specific tour with the user define events and the recommended events. For example, the specific tour may include shopping activities during a certain time period, but the user may want to go to the beach at the same time. The user account can replace the shopping activities with going to beach from either the user define events or the recommended events. Then the planning engine updates the specific tour and the electronic calendaring system according to the new changes. If one of the optional activities is dragged onto an incorrect time slot in the specific tour, the present invention prompts the user account for the correct time on the electronic calendaring system. The present invention provides a detail view for each of the desired destinations in the specific tour. The user account can click on each of the desired destinations in the specific tour and activate the detail view. The detail view displays the event profile, the venue profile, the special offers, and the reservation information. For example, if one of the desired destinations is a dinner out, the dinner out includes the detail view with all the necessary information, such as restaurant name, restaurant address, restaurant pictures, and the reservation link for opentable.com so that the user can place a reservation through opentable.com.

The default view of the specific tour in the electronic calendaring system is a function of time. For example, if the specific tour has not yet occurred, the electronic calendaring system illustrates the entire timeline. At the same time, if the specific tour is in progress, the electronic calendaring system illustrates the remaining timeline of the specific tour. The default view of the specific tour allows the user account to set reminders for each of the plurality of destinations in the specific tour, but the user account can also turn off the reminders. The reminders are categorized into two separate categories which are travel reminders and event reminders. The user account can modify the setting for the reminders so that travel reminders and the event reminders are set up with predetermined time limits. For example, the user can modify the travel reminders with three hours in advance and event reminders with twenty minutes in advance. The travel reminders correlate with the plurality of desired destinations, and the event reminders correlate with travel options. The user account can accept, skip, reschedule, or delay the reminders upon user's preference.

The electronic calendaring system includes a geo-optimizer, a weather-optimizer, and a packing list. The geo-optimizer provides the distance between two desired destinations, travel time between two desired destinations, or any other related information about the plurality of destinations. The geo-optimizer minimized going from place to place and crisscrossing back and forth so that the specific tour is optimized. For example, if one of the desired destinations in the specific tour gets change or cancel, the electronic calendaring system is updated according to the changes so that the user can be notified. The geo-optimizer also allows the user account to search for nearby events that matches with the COI and search for parking availability. The weather-optimizer provides forecasted weather condition of the desired destinations. The weather-optimizer notifies the user account about the forecasted weather condition, and updates the optional activities according to the forecasted weather condition so that the user account can update the specific tour with reference to the weather. The packing list displays essential items that the user may need for the specific tour. The packing list constantly updates according to the weather-optimizer since different weather conditions call for different essential items. If the user invariably stays longer or shorter than what the electronic calendaring system has planned, the present invention facilitates optional way to prompt the user account in order to complete the specific tour, and the optional ways are updated through the electronic calendaring system. For example, the user account can skip any of the desired destinations of the specific tour, then the electronic calendaring system optimizes according to the changes. Before the selected desired destination is skipped, the present invention prompts a question to the user account asking the reason for skipping the selected desired destination and verifying the skipping of the selected desired destination so that accidental skipping can be prevented.

The present invention then sends a plurality of alerts to the user account in order to check pre-trip features where the pre-trip features comprises house related tasks and trip related tasks. The pre-trip features allow the user to fully prepare for the specific tour without any mishaps. The house related tasks comprises stop paper, stop mail, pay bills, inform neighbors and family, arrange trash pickup, set timers for house lights, and any other similar tasks. The trip related tasks comprises buy batteries, print out trip information, reservation for transportation, set up reservations for events that are not reserved through the present invention, check passport and visa, and any other similar tasks.

Then the present invention prompts the user account to select final selections from lists of cost optimizing options. The lists of cost optimizing options include the travel options, saving opportunities, and dynamic trip analyzers. The dynamic trip analyzers optimize the specific tour with reference to the financial cost so that the user is fully satisfied. The saving opportunities search the internet for variety of savings with reference to the specific tour so that the user can get the maximum value for the financial cost. The travel options display different travel method such as, air, cruise, car, and any other type of transportation method so that the user can select the relevant travel options in a cost effective way. The travel option may alternately seek third party traveling sites such as Expedia or Travelocity. Once the user account selects the final selections from the travel options, the saving opportunities, and the dynamic trip analyzers, the present invention retrieves the final selections. Then the specific tour and the final selections are assigned as a finalized tour within the present invention.

The user account can purchase the finalized tour through an online transaction. After the finalized tour is purchased, the plurality of host accounts related to the finalized tour is instantly notified by the present invention with real time updates. Because of the fact that the plurality of host accounts is notified by the present invention, each of the plurality of host accounts increases awareness and visibility at point of sale and achieves low no show rates. The present invention also creates a passenger name record for the finalized tour within the tour database. The present invention then sends the electronic calendaring system to a mobile computing device of the user account. The electronic calendaring system may also symphonize with internet connection sharing compatible calendars such as Microsoft Outlook, Yahoo calendar, Google calendar, etc. The user account can also print out the finalized tour with many different view such as, portable document format (PDF) of the finalized tour, the week view of the finalized tour, the entire tour view of the finalized tour, the event view of the finalized tour, and the icon view of the finalized tour. After the finalized tour is completed by the user, and a pre-determined time period is passed through, the finalized tour can't be altered or downloaded by the user account, but the finalized tour can be view by the user account. An administrative team of the present invention is only allowed to access the finalized tour once the finalized tour passes the pre-determined time period.

The specific tour, that is either not purchased by the user account or wishes to take in near future, is assigned as a dream tour within the present invention. Since the user account can have more than one dream tours, the user account can activate each of the dream tours through the link. Whenever the user is ready to take the dream tour, the user can select the final selections and purchase the finalized tour through the user account. The present invention also assigns the finalized tour as a completed tour when the finalized tour is purchased or completed by the user. The dream tours and the completed tours can be displayed to the user account through the website. The user account can also name each of the dream tours and the completed tours with personalized name.

The present invention prompts the user account to complete a quality grade report for the completed tour where the quality grade report provides an overall rating for the completed tour. The quality grade report includes ranking where number ten being the highest rating and number one being the lowest rating. The user account can complete the quality grade report during the specific tour so that real time updates can be uploaded for each of the desired destinations. Alternately, the user account can complete the quality grade report after the specific tour is completed. The quality grade report is stored within a rating database. Since the quality grade report provides additional understanding about the user, the quality grade report is used for future preference surveys, future specific tours, and future recommended events. For example, if the user has attended a music concert, the present invention may prompt the user account to answer specific questions regarding music concerts through the plurality of preference surveys. The quality grade report is also compared with the ratings from other travel websites such as travelpost.com, tripadvisor.com, and kayak.com. Whenever the user account prompts the additional specific tours after the first specific tour, the additional specific tours are generated according to the plurality of completed preference surveys and the quality grade reports.

The present invention may be released with three different versions. A first version mainly depends on the plurality of host accounts and the convention and visitor bureaus so that the plurality of destinations is high quality, and the administrative team can observe what aspects of the present invention is efficient and what aspects need to be improved. The first version may include the top US travel destinations. For example, the potential top US travel destinations in the present invention are list below.

1. Orlando, Fla. (Disney World, Universal Studios, Sea World)

2. Manhattan/NYC, N.Y.

3. Las Vegas, Nev.

4. Grand Canyon, Ariz.

5. Hawaii (Honolulu and more)

6. Niagara Falls, N,Y.

7. San Francisco, Calif.

8. Napa Valley, Calif.

9. Key West, Fla.

10. Yosemite National Park, CA

11. Miami Normandy/Fort Lauderdale, Fla.

12. Chicago, Ill.

13. Washington, D.C.

14. Boston, Mass.

15. Anaheim, Calif. (Disneyland Park)

16. San Antonio, Tex.

17. Salt Lake City, Utah

18. Hollywood, CA & Los Angeles, Calif.

19. Cape Cod National Seashore, MA

20. San Diego, Calif. (and Sea World)

21. Atlantic City, N.J.

22. Hilton Head, S.C.

23. Adirondacks Park, NY

24. California North Coast (SF to Redwood Forest National Park Scenic Drive)

25. Long Island, N.Y.

26. Carmel & Pebble Normandy, Calif.

27. Mammoth Cave National Park,

28. Great Smoky Mountains

29. Austin, Tex.

30. Sandusky and Lake Erie, Ohio

31. Colorado Springs and Denver, Colo.

32. Baltimore, Md.

33. Philadelphia, Pa. (and Lancaster County, Amish Country)

34. Alaska (need to do more research on “what” in Alaska as it's not just a city)

35. New Orleans, La.

36. Yellowstone National Park, WY

37. Seattle, Wash.

38. Annapolis, Md.

39. Atlanta, Ga.

40. Branson, Mo.

41. Charleston, S.C.

42. Dallas, Tex.

43. Pittsburgh, Pa.

44. Jackson Hole, Wyo.

45. Jamestown/Williamsburg/VA Normandy/Richmond, Va.

46. Kansas City, Kans.

47. Memphis, Tenn.

48. Newport, R.I.

49. Palm Springs, Calif.

50. Phoenix, Ariz.

51. Portland, Oreg.

52. Raleigh, N.C.

53. Charlotte, N.C.

54. Houston, Tex.

55. Tampa/St. Petersburg

After the first version, a second version is released where the second version uses a hybrid approach to populate the plurality of destinations by implementing a web crawler. The web crawler provides information on lesser traveled destination so that the plurality of destinations can be improved. Additionally, the number of the plurality of destinations is increased compared to the first version, including large international destinations. The information is gathered by the host accounts as well as by experimentation with the web crawler can provide the web crawler results for the host accounts to leverage. The second version of the present invention can also include information for each of the plurality of destinations whose information has been gathered by the crawler only. A third version of the present invention gathers additional plurality of destinations form the host accounts. In addition, the web crawler is fully implemented.

The present invention expects to offer specific tours for any destinations beyond the plurality of destinations which are stored within the content database. The third version of the present invention relies much more on the web crawler and less on the plurality of host accounts. Basic version of the present invention can be released to business travelers and group travelers such as children support programs. The basic version is offered as primarily a calendar tool for the users who are not traveling to the top US travel destinations.

The present invention provides advertising spaces in the website so that advertising can be promoted to gain revenue. Different companies can advertise their merchandises or services within the advertising spaces. The administrative team selectively chooses the different companies in order to optimize the efficiency of the present invention, and a custom landing page can be offered for those companies. The host account may lunch advertising with reference to the plurality of destinations so that the host account can obtain increase sales. The website may also include a search option, where the search option allows the user account to search stored information in the present invention. The present invention may also operate as a mobile application on smartphones or electronic tablets. All the functionality described in the present invention is accomplished within the mobile application with minimal impact to the mobile device performance, battery life, and storage requirements. The user account needs to enter the user name and the user password which are store encrypted on the smartphones or electronic tables. The information is then decrypted at the initial lunching of the mobile application and stored in the phone memory in order to authenticate the present invention.

The present invention may function as a social media network for travel and performs as viral marketing tool in between each of the plurality of user accounts. For example, the user may take a picture of a sunset and upload to the website with a brief message. Then predefined users accounts of the present invention are able to view the sunset picture and the brief message. Since the predefined user accounts see the sunset picture and the brief message, the present invention facilitates viral marketing through the website. The interaction of each of the plurality of user accounts transforms the present invention into the social media network for travel so that each of the plurality of user accounts can discuss travel ideas as they are occurring or after they have occurred. The present invention also includes a privacy policy statement or a legal document informing the user account about all of the legal and ethical policies.

The present invention functions as an iterative learning system which provides the basis for the specific tours in the user account to matches with the COI completed by the user account. Over time, the iterative learning system learns more about each of the plurality of user accounts, minimizes the bail-out rate of the plurality of user accounts, and maximizes the sales opportunities. Since the COI and the quality grade report include assigned weights from the ratings, the iterative learning system continuously improves the recommended events according to the COI and the quality grade report to ensure user retention. The iterative learning system performs crowd-sourcing according to the demographics and psychographics because similar ethnic groups have similar interest. The iterative learning system also lists the optional activities from highly rated to least rated. The iterative learning system also prompts visitors of the present invention to create a user account with a friendly and creative manner.

A privilege fee functions as the financial aspect of the present invention. The present invention can charge the privilege fee from the user account and the host account to create revenue. The host account may have to pay the privilege fee when the host account uploads the plurality of destinations, and the user account may have to pay the privilege fee when the finalized tour is purchased. Additionally, the present invention can also be used by travel agencies and supplier companies by paying the privilege fee monthly.

Although the invention has been explained in relation to its preferred embodiment, it is to be understood that many other possible modifications and variations can be made without departing from the spirit and scope of the invention as hereinafter claimed.

What is claimed is:

1. A method of event and venue planning and delivering system through a non-transitory computer-readable medium by executing computer-executable instruction comprises the steps of:
prompting a host account to upload a plurality of destinations through an input form, wherein the plurality of destinations includes venue profiles, event profiles, special offers, and reservation information;
electronically retrieving the plurality of destinations through convention and visitor bureaus;
prompting a user account to complete a plurality of preference surveys, wherein the user account includes a user name, a user password, and a user profile;
planning a specific tour with optional activities for the user account according to the plurality of preference surveys, wherein the specific tour includes desired destinations from the plurality of destinations;
displaying the specific tour to the user account within an electronic calendaring system by a planning engine;
sending a plurality of alerts to the user account in order to check pre-trip features, wherein the pre-trip features include house related tasks and trip related tasks;
prompting the user account to choose final selections for the specific tour from lists of cost optimizing options;
assigning the specific tour and the final selections as a finalized tour;
prompting the user account to purchase the finalized tour through an online transaction; and
notifying the host account, if the user account purchases the finalized tour.

2. The method of event and venue planning and delivering system through a non-transitory computer-readable medium by executing computer-executable instruction comprises, the method as claimed in claim 1 further comprises the steps of:
retrieving the venue profiles, the event profiles, the special offers, and the reservation information through the host account and the convention and visitor bureaus;
validating the venue profiles, the event profiles, the special offers, and the reservation information; and
storing the venue profiles, the event profiles, the special offers, and the reservation information within a content database.

3. The method of event and venue planning and delivering system through a non-transitory computer-readable medium by executing computer-executable instruction comprises, the method as claimed in claim 1 further comprises the steps of:
storing the user name, the user password, and the user profile for the user account within a member database;
granting access to the user account by retrieving the user name and the user password or through a social network account;
storing a link for the specific tour within the member database;
storing the optional activities within the member database; and
storing the plurality of preference surveys within the member database, wherein the plurality of preference surveys is categorized with destination preferences, data specific preferences, and trip preferences.

4. The method of event and venue planning and delivering system through a non-transitory computer-readable medium by executing computer-executable instruction comprises, the method as claimed in claim 1 further comprises the steps of:
prompting the user account to complete a first survey from the plurality of preference surveys, when the user account is initially created; and
continuously prompting the user account to complete additional surveys from the plurality of preference surveys, wherein the additional surveys are completed by the user account every time the user account is activated.

5. The method of event and venue planning and delivering system through a non-transitory computer-readable medium by executing computer-executable instruction comprises, the method as claimed in claim 1 further comprises the steps of:
planning the specific tour for the user account according to the plurality of preference surveys by the planning engine;
storing the specific tour within a tour database;
enabling the user account to complete the specific tour, if the specific tour is partially planned;
creating a passenger name record for the finalized tour within the tour database; and
sending the finalized tour to a mobile computing device of the user account, if the finalized tour is purchased.

6. The method of event and venue planning and delivering system through a non-transitory computer-readable medium by executing computer-executable instruction comprises, the method as claimed in claim 5 further comprises the steps of:
assigning the specific tour as a dream tour, if the specific tour is not purchased by the user account or the user account wishes to eventually take the specific tour;
assigning the finalized tour as a completed tour, if the finalized tour is purchased or completed by the user account;
prompting the user account to complete a quality grade report for the completed tour, wherein number ten being the highest rating and number one being the lowest rating; and
storing the quality grade report in a rating database.

7. The method of event and venue planning and delivering system through a non-transitory computer-readable medium by executing computer-executable instruction comprises, the method as claimed in claim 1 further comprises the steps of:
planning the specific tour for the user account according to the plurality of preference surveys by a consultant service, wherein the consultant service communicates with the user account;
storing the specific tour within a tour database by the consultant service;
prompting the user account to complete the specific tour through the consultant service, if the specific tour is partially planned;
creating a passenger name record for the finalized tour within the tour database; and
sending the finalized tour to a mobile computing device of the user account, if the finalized tour is purchased.

8. The method of event and venue planning and delivering system through a non-transitory computer-readable medium by executing computer-executable instruction comprises, the method as claimed in claim 7 further comprises the steps of:
assigning the specific tour as a dream tour, if the specific tour is not purchased by the user account or the user account wishes to take the specific tour in the future;
assigning the finalized tour as a completed tour, if the finalized tour is purchased or completed by the user account;
prompting the user account to complete a quality grade report for the completed tour, wherein number ten being the highest rating and number one being the lowest rating; and
storing the quality grade report in a rating database.

9. The method of event and venue planning and delivering system through a non-transitory computer-readable medium by executing computer-executable instruction comprises, the method as claimed in claim 1 further comprises the steps of:
displaying the optional activities to the user account along with the electronic calendaring system, wherein the optional activities include user defined events and recommended events;
enabling the user account to selectively interchange the plurality of destinations in the electronic calendaring system with each of the user defined events and the recommended events;
displaying a geo-optimizer through the electronic calendaring system, wherein the geo-optimizer provides the distance and time between each of the desired destinations;
displaying a weather-optimizer through the electronic calendaring system, wherein the weather-optimizer forecasted weather condition of each of the desired destinations; and
displaying a packing list through the electronic calendaring system, wherein the packing list is based upon forecasted weather condition.

10. The method of event and venue planning and delivering system through a non-transitory computer-readable medium by executing computer-executable instruction comprises, the method as claimed in claim 9 further comprises the steps of:
prompting the user account to update each of the desired destinations with the geo-optimizer;
optimizing the specific tour with the geo-optimizer;
retrieving the forecasted weather of the desired destinations with the weather-optimizer; and
optimizing the specific tour with the weather-optimizer.

11. The method of event and venue planning and delivering system through a non-transitory computer-readable medium by executing computer-executable instruction comprises, the method as claimed in claim 1 further comprises the steps of:
prompting the user account to select travel options, saving opportunities, and dynamic trip analyzers from the lists of cost optimizing options;
retrieving the final selections from the travel options, the saving opportunities, and the dynamic trip analyzers; and
optimizing the specific tour with the dynamic trip analyzers with reference to the financial cost.

12. The method of event and venue planning and delivering system through a non-transitory computer-readable medium by executing computer-executable instruction comprises, the method as claimed in claim 11 further comprises the steps of:
wherein the travel options, the saving opportunities, and the dynamic trip analyzers influence the price of the finalized tour.
